(19) United States
(12) Patent Application Publication
(10) Pub. No.: US 2025/0109965 A1
(43) Pub. Date: Apr. 3, 2025

(54) USER INPUT FOR INTERACTING WITH DIFFERENT MAP DATA

(71) Applicant: Apple Inc., Cupertino, CA (US)

(72) Inventors: Moritz VON VOLKMANN, Sunnyvale, CA (US); Christopher P. FOSS, San Francisco, CA (US); Andrew S. KIM, Walnut Creek, CA (US); David A. KRIMSLEY, Sunnyvale, CA (US); Corey K. WANG, Palo Alto, CA (US)

(21) Appl. No.: 18/896,677

(22) Filed: Sep. 25, 2024

Related U.S. Application Data
(60) Provisional application No. 63/541,821, filed on Sep. 30, 2023.
(60) Provisional application No. 63/541,810, filed on Sep. 30, 2023.
(60) Provisional application No. 63/587,108, filed on Sep. 30, 2023.

(51) Int. Cl. G01C 21/00

(52) U.S. Cl. CPC G01C 21/3856

(57) ABSTRACT

The present disclosure generally relates to interacting with different map data.

### CROSS-REFERENCE TO RELATED APPLICATIONS

This application claims priority to U.S. Provisional Patent Application Ser. No. 63/541,821 entitled, “USER INPUT FOR INTERACTING WITH DIFFERENT MAP DATA,” filed Sep. 30, 2023, to U.S. Provisional Patent Application Ser. No. 63/541,810 entitled, “TECHNIQUES FOR CONFIGURING NAVIGATION OF A DEVICE,” filed Sep. 30, 2023, and to U.S. Provisional Patent Application Ser. No. 63/587,108 entitled, “TECHNIQUES AND USER INTERFACES FOR PROVIDING NAVIGATION ASSISTANCE,” filed Sep. 30, 2023, which are incorporated by reference herein in their entireties for all purposes.

### FIELD

The present disclosure relates generally to computer user interfaces, and more specifically to techniques for interacting with different map data.

### BACKGROUND

Electronic devices are often capable of navigating to destinations using available map data. While navigating, the electronic device can encounter physical areas with different qualities of map data. The quality of the map data can cause errors resulting in incorrect navigation instructions.

### SUMMARY

Some techniques for interacting with different map data using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for interacting with different map data. Such methods and interfaces optionally complement or replace other methods for interacting with different map data. Such methods and interfaces reduce the cognitive burden on a user and produce a more efficient human-machine interface. For battery-operated computing devices, such methods and interfaces conserve power and increase the time between battery charges, for example, by reducing the number of unnecessary, extraneous, and/or repetitive received inputs and reducing battery usage by a display.

In some embodiments, a method that is performed at a computer system that is in communication with one or more output components is described. In some embodiments, the method comprises: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a non-transitory computer-readable storage medium storing one or more programs configured to be executed by one or more processors of a computer system that is in communication with one or more output components is described. In some embodiments, the one or more programs includes instructions for: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a transitory computer-readable storage medium storing one or more programs configured to be executed by one or more processors of a computer system that is in communication with one or more output components is described. In some embodiments, the one or more programs includes instructions for: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a computer system that is in communication with one or more output components is described. In some embodiments, the computer system that is in communication with one or more output components comprises one or more processors and memory storing one or more programs configured to be executed by the one or more processors. In some embodiments, the one or more programs includes instructions for: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a computer system that is in communication with one or more output components is described. In some embodiments, the computer system that is in communication with one or more output components comprises means for performing each of the following steps: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a computer program product is described. In some embodiments, the computer program product comprises one or more programs configured to be executed by one or more processors of a computer system that is in communication with one or more output components. In some embodiments, the one or more programs include instructions for: receiving a request to navigate to a first destination; in response to receiving the request, initiating navigation to the first destination; and while navigating to the first destination: in accordance with a determination that an intended traversal area includes a first quality of map data, requesting, via the one or more output components, input with respect to an upcoming maneuver; and in accordance with a determination that the intended traversal area includes a second quality of map data different from the first quality of map data, forgoing requesting input with respect to the upcoming maneuver.

In some embodiments, a method that is performed at a computer system that is in communication with one or more output components is described. In some embodiments, the method comprises: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

In some embodiments, a non-transitory computer-readable storage medium storing one or more programs configured to be executed by one or more processors of a computer system that is in communication with one or more output components is described. In some embodiments, the one or more programs includes instructions for: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

In some embodiments, a transitory computer-readable storage medium storing one or more programs configured to be executed by one or more processors of a computer system that is in communication with one or more output components is described. In some embodiments, the one or more programs includes instructions for: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

In some embodiments, a computer system that is in communication with one or more output components is described. In some embodiments, the computer system that is in communication with one or more output components comprises one or more processors and memory storing one or more programs configured to be executed by the one or more processors. In some embodiments, the one or more programs includes instructions for: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

In some embodiments, a computer system that is in communication with one or more output components is described. In some embodiments, the computer system that is in communication with one or more output components comprises means for performing each of the following steps: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

In some embodiments, a computer program product is described. In some embodiments, the computer program product comprises one or more programs configured to be executed by one or more processors of a computer system that is in communication with one or more output components. In some embodiments, the one or more programs include instructions for: receiving a request to navigate to a first destination; in response to receiving the request, initiating navigation to the first destination; and while navigating to the first destination: in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for interacting with different map data, thereby increasing the effectiveness, efficiency, and user satisfaction with such devices. Such methods and interfaces may complement or replace other methods for interacting with different map data.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2H illustrate exemplary user interfaces for interacting with different map data in accordance with some embodiments.

FIG. 3 is a flow diagram illustrating methods for interacting with different map data in accordance with some embodiments.

FIG. 4 is a flow diagram illustrating methods for interacting with different map data in accordance with some embodiments.

### DETAILED DESCRIPTION

The following description sets forth exemplary techniques for interacting with different map data. This description is not intended to limit the scope of this disclosure but is instead provided as a description of example implementations.

Users need electronic devices that provide effective techniques for interacting with different map data. Efficient techniques can reduce a user's mental load when interacting with different map data. This reduction in mental load can enhance user productivity and make the device easier to use. In some embodiments, the techniques described herein can reduce battery usage and processing time (e.g., by providing user interfaces that require fewer user inputs to operate).

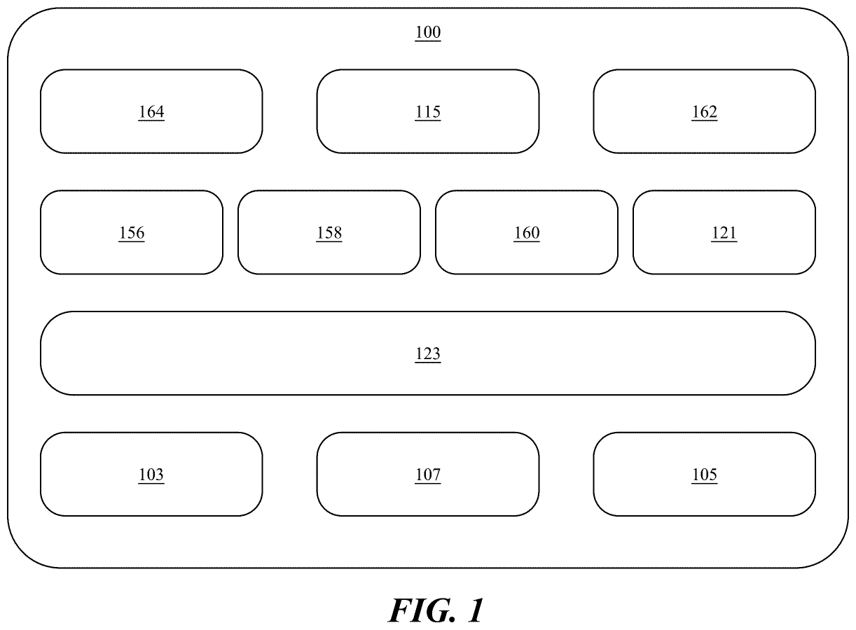

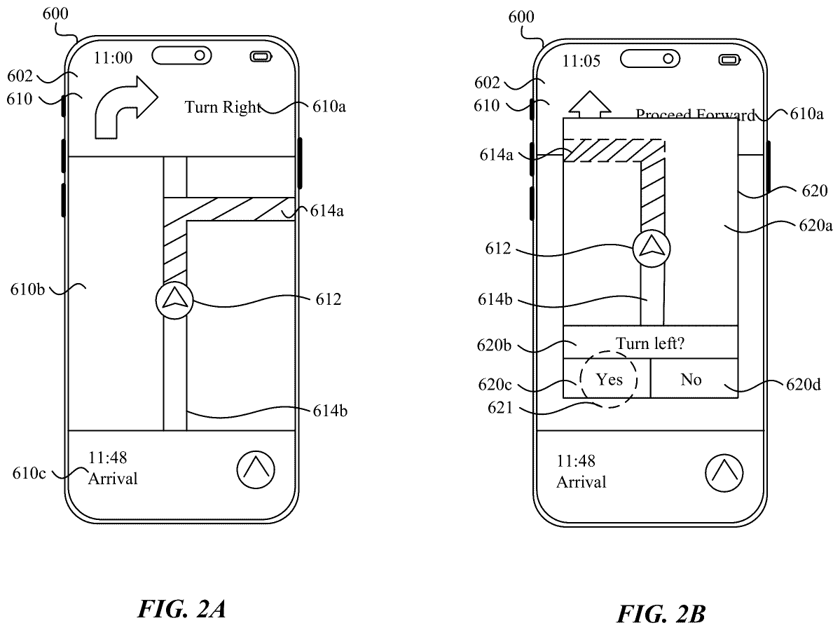

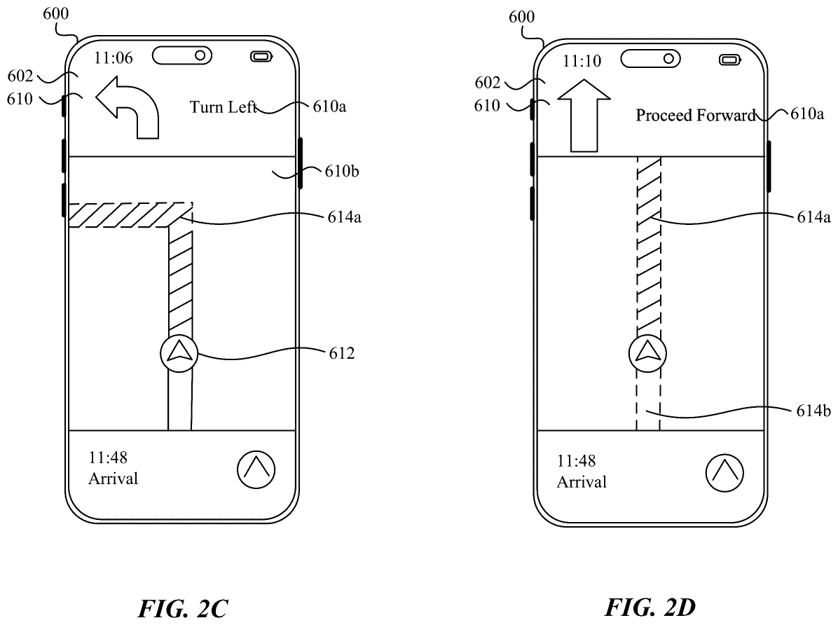

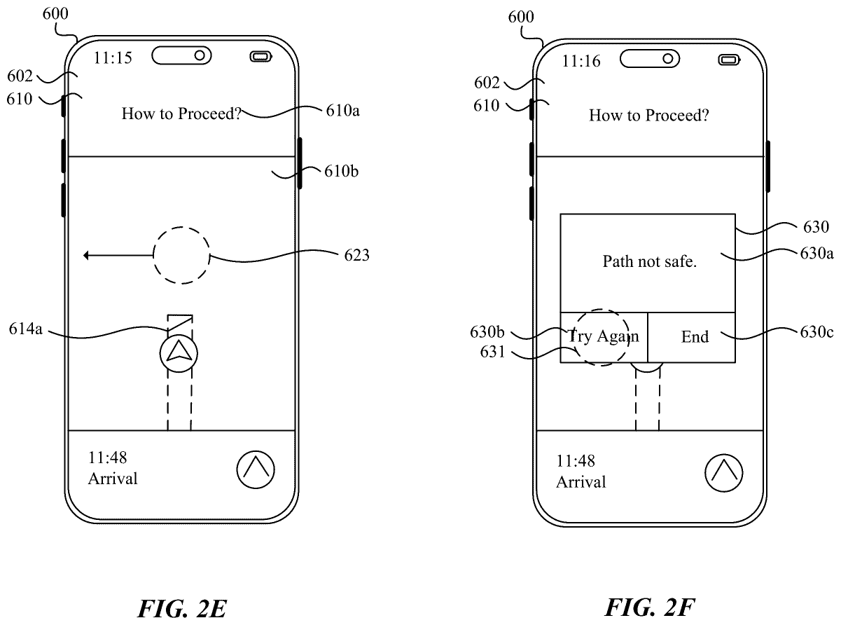

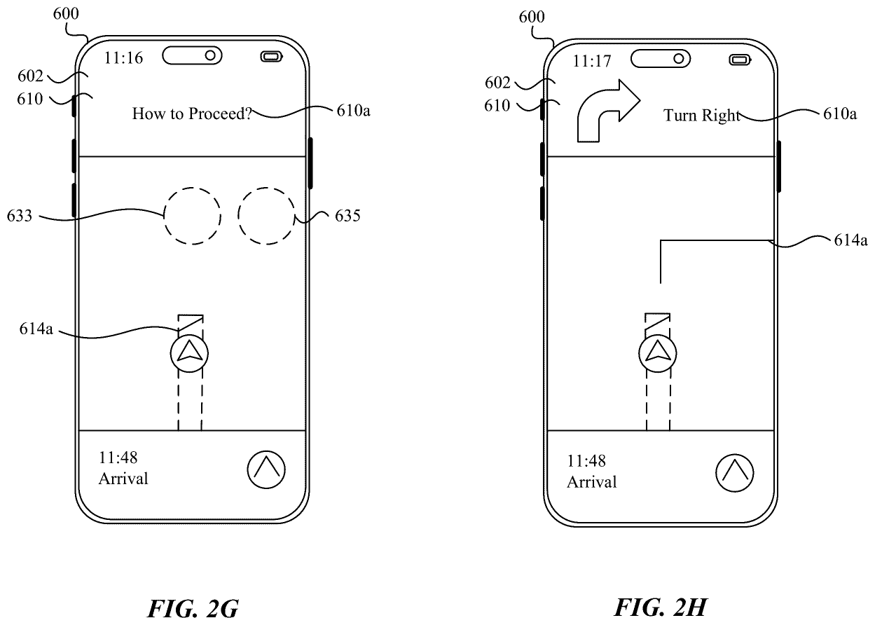

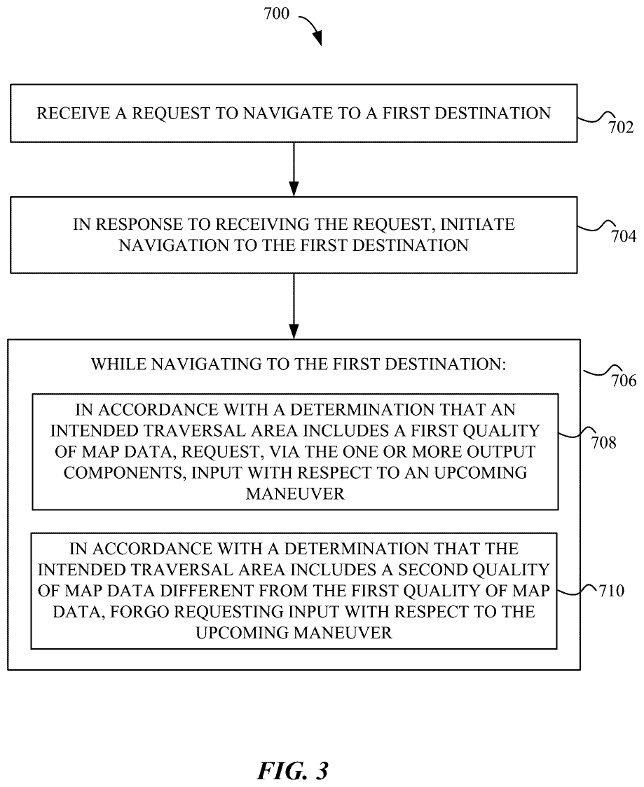

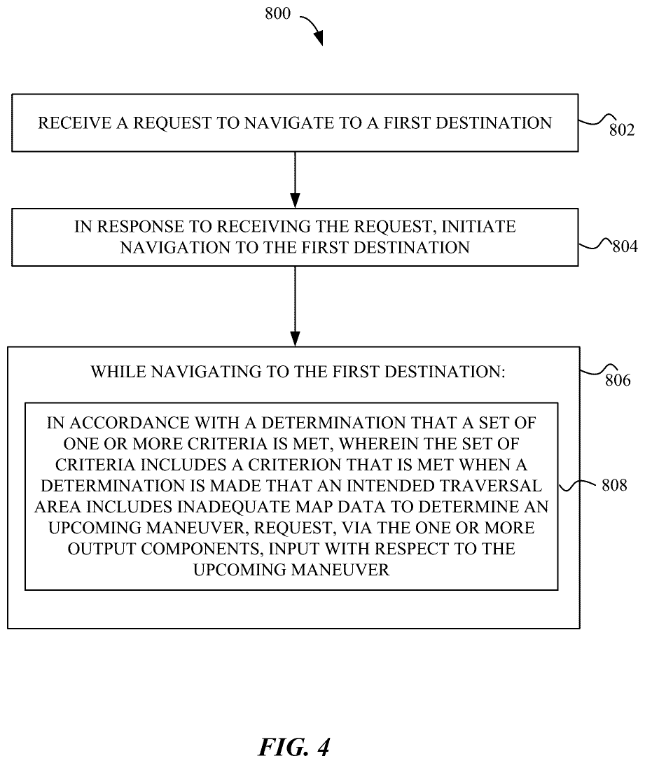

FIG. 1 provides illustrations of exemplary devices for performing techniques for interacting with different map data. FIGS. 2A-2H illustrate exemplary user interfaces for interacting with different map data in accordance with some embodiments. FIG. 3 is a flow diagram illustrating methods for interacting with different map data in accordance with some embodiments. FIG. 4 is a flow diagram illustrating methods for interacting with different map data in accordance with some embodiments. The user interfaces in FIGS. 2A-2H are used to illustrate the processes described below, including the processes in FIGS. 3 and 4.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in

communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3 and/or 4 (e.g., processes 700 and/or 800) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input component(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output component(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input component.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output component(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output component(s) 160. In some embodiments, output component(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input component(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input component(s) 158 to detect the user speaking one or more words. In some embodiments, system 100 parses and/or communicates information to one or more other systems to determine contents of the speech of the user, including identifying words and/or obtaining a semantic understanding of the words. For example, processor(s) 103 can be configured to perform natural language processing to detect one or more words and/or determine a likely meaning of the one or more words in the sequence spoken by the user. Additionally, or alternatively, in some embodiments, the system 100 determines the meaning of the one or more words in the sequence spoken based upon a context of the user determined by the system 100.

In some embodiments, system 100 outputs spatial audio via output component(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device (e.g., computer system 600), such as system 100.

FIGS. 2A-2H illustrate exemplary user interfaces for interacting with different map data, in accordance with some embodiments. The user interfaces in these figures are used to illustrate the processes described below, including the processes in FIGS. 3 and 4. Throughout the user interfaces, user input is illustrated using a circular shape with dotted lines (e.g., user input 621 in FIG. 2B). It should be recognized that the user input can be any type of user input, including a tap on touch-sensitive screen, a button press, a gaze toward a control, a voice request with an identification of a control, a gesture made by a user and captured by a camera, and/or any other affirmative action performed by a user. In some examples, a single representation of a user input in a figure (1) includes one or more different types of user input and/or (2) represents different types of user input to result in different operations. For example, a single illustrated user input can be a tap input, a tap-and-hold input, and/or a swipe gesture.

FIG. 2A illustrates navigation user interface 610 for interacting with different map data. Computer system 600 displays navigation user interface 610 on touchscreen display 602. In some embodiments, the device being navigated is the device that displays navigation user interface 610 (e.g., computer system 600). In some embodiments, the device being navigated is a device other than the device that displays navigation user interface 610. For example, the device being navigated is in communication with the device that displays navigation user interface 610.

Navigation user interface 610 includes navigation instruction 610a, map 610b, and arrival information 610c. Navigation instruction 610a indicates a current instruction to a user of navigation user interface 610. In FIG. 2A, navigation instruction 610a indicates the instruction textually (e.g., “Turn Right”) and visually (e.g., right turn arrow graphic). Other examples of navigation instructions include “turn left”, “proceed straight”, “continue for 3 kilometers”, and/or “turn around.” Map 610b includes a visual representation of a geographic location (e.g., the location surrounding the device being navigated) (e.g., computer generated graphic and/or an image captured by one or more cameras). It should be recognized that navigation user interface 610 can include different, less, and/or more user interface elements than illustrated in FIG. 2A.

In some embodiments, a map (e.g., 610b) is generated based on one or more pieces of map data. Such map data can describe one or more features of the map, such as the location of roadways, paths, trails, and/or rail lines, terrain/topology data, traffic data and/or other conditions data, building data, and/or graphic elements for displaying the map. Map data can also include data from one or more on-device sensors (e.g., that are part of the device being navigated and/or part of the device displaying navigation user interface 610) and/or one or more external sensor (e.g., a stationary camera that transmits its data to the device being navigated when they are within a threshold proximity). In some examples, the sensor data is measured and transmitted in real-time or near-in-time as the device being navigated approaches or is physically present/near the measured area.

As will be appreciated by one of ordinary skill in the art, there are many types and sources of data that can be input into a process for determining a navigation route. These different pieces of data can be used in different ways and/or at different times during the process of determining a navigation route. For example, if map data is available from a verified and/or trusted source (e.g., verified by a first-party developer of the navigation application), navigation along a route indicated by the trusted source can be weighed more heavily by the process (e.g., and thus be preferred and/or be more likely to be selected) in making a routing decision as compared to a similar route from an untrusted source. As another example, map data from a trusted source can be used to determine an initial route, but during navigation along that route received sensor data can indicate that the route is impassable (e.g., a path is closed, not safe, and/or no longer exists)-the navigation process for determining navigation can take into account the sensor data to override and/or aide the route derived or received from the trusted data source and, for example, select a different route (e.g., perhaps from an unverified data source, depending on the available options).

In some embodiments, map data has (e.g., is associated with) a state. In the examples that follow, this disclosure will refer to map data as having an associated “state”. This state can, for example, be a function of (e.g., determined in whole or in part by) the type(s) and/or source(s) of data that make up the map data. For example, data that is from a verified source can be considered as having a different state than data from an unverified source. Similarly, two pieces of data from a verified source can have different states, where a first of such pieces of data is in conflict with sensor data (e.g., obstruction detected on the path) and second of such pieces of data is not in conflict with the sensor data (e.g., path is clear). Thus, whether map data is of a particular state can be based on one or more criteria. In some examples, the term “state” refers to a classification or identification of map data that satisfies a set of one or more criteria (e.g., classified by the device being navigated, the device displaying navigation user interface 610, and/or a server in communication with either or both of such devices). How such states are defined (e.g., which set of one or more criteria is used to delineate states) can be different based on the intended use of the map data (e.g., the type of decision being made based on the state). For example, states that represent how recently associated data was updated (e.g., how fresh the data is) can be considered by a certain subprocess or decision within a navigation routing process (e.g., in an urban area where traffic level can be highly dynamic), yet not be considered by another subprocess or decision within the navigation routing process (e.g., determining whether the pathway is physically passable (e.g., paved or not) based on the type of navigation (e.g., via car, via bike, and/or on foot)). In some examples, map data “state” is referred to as a “level,” “category,” or other appropriate phrase that can be recognized by one of ordinary skill in the art.

The examples depicted in FIGS. 2A-2H involve user interfaces associated with one of four example states. The four example states are distinct states based on two criteria: (1) whether or not sufficient map data can be retrieved from a storage resource (e.g., memory of computer system 600 and/or a server), and (2) whether or not the navigation application (and/or a device or server in communication with the navigation application) can determine a recommended path based on the available map data (e.g., from any source). For criterion (1), retrieved map data can be considered “sufficient” if it is verified and/or trusted (e.g., comes from a verified source, such as the developer of the navigation application, and/or a source trusted by the navigation application (e.g., an owner of the premises represented by the map data)), and can be considered “insufficient” if no (or not enough) map data can be retrieved, if the retrieved map data is not verified and/or trusted (e.g., lacks a trust and/or verification credential associated with a verified and/or trusted source), if the retrieved map data does not include enough information for determining a recommended path (e.g., on its own), and/or any other appropriate criterion to delineate whether sufficient data could not be retrieved from a data source. For criterion (2), whether or not the navigation application can determine a recommended path based on the available map data (e.g., from any source) can be based on whether map data can be derived (e.g., collected and/or created) from one or more sources of data (e.g., other than the storage resource) (e.g., one or more sensor, and/or one or more unverified and/or untrusted source) that is sufficient for determining (e.g., by the navigation application) a recommended path. In some examples, deriving map data includes creating map data. For example, creating map data can include creating a new map when map data does not exist and/or adding information to an existing map when map data is insufficient, incomplete, and/or incorrect (e.g., outdated). In some examples, deriving map data includes creating map data with objects, paths, and/or other aspects of a physical environment that are not defined and/or specified in the available map data. For example, sufficient map data may not be available from the storage resource (e.g., criterion (1) is not satisfied); however, the navigation application can derive map data from sources such as on-device cameras and/or other sensors. In some examples, the derived map data is sufficient (e.g., for the navigation application and/or a process and/or device in communication therewith) to determine a recommended path. For example, deriving map data and determining a path based on the derived map data stands in contrast to the device simply receiving map data and then positioning itself within the received map data (e.g., using GPS data). Whether a navigation application (and/or associated process) can determine a recommended path can be affected by several factors including the external environment and the specific process used to determine a recommended path (e.g., depending on the parameters of such process). For example, a navigation application can require that a path determined by its navigation path determination processes have an associated confidence value above a certain threshold before recommending the route to a user (e.g., as depicted in FIG. 2F using navigation user interface 610). If enough map data is collected to determine a possible path, but such possible path does not have the requisite confidence value, the possible path would not be recommended and thus second criterion would indicate that the navigation application cannot determine a recommended path. In summary, for a set of states based on criteria (1) and (2) above, map data can have one of at least four possible states: a first state {sufficient map data from storage resource; recommended path can be determined based on collected map data}, a second state {sufficient map data from storage resource; no recommended path can be determined based on collected map data}, a third state {insufficient map data from storage resource; recommended path can be determined based on collected map data}, and a fourth state {insufficient map data from storage resource; no recommended path can be determined based on collected map data}. More, less, and/or different criteria can be used to determine a map data state. In making one or more decision (e.g., regarding whether to proceed with or without prompting for user input), a navigation application can use all, some, or none of the possible states. For example, the second state may never (or rarely) logically occur because if sufficient map data is retrieved from a storage resource, then a recommended path should be determinable. In some embodiments, computer system 600 receives data from one or more other computer systems of the same, similar, and/or different type as computer system 600. For example, another computer system can be navigating an environment using one or more sensors of the other computer system. The other computer system can detect and/or derive information corresponding to the environment using data detected by the one or more sensors. Computer system 600 can receive the information either directly from the other computer system and/or through another device, such as a server. Such information can be detected near in time and/or location to where computer system 600 is navigating.

Referring to FIG. 2A again, map 610b includes indicator 612 representing the current position of the device being navigated (e.g., computer system 600 in this example). Map 610b also include navigation path 614a representing the upcoming portion of the navigation (e.g., as determined and suggested by the navigation application). Map 610b also includes example navigation path 614b representing a previously travelled portion of the navigation. Navigation path 614b can have a visual appearance that indicates that a path was traveled, or simply appear with the default visual appearance of the underlying path (e.g., as if no navigation is programmed). In FIG. 2A, navigation path 614a is based on map data associated with the first state {sufficient map data from storage resource; recommended path can be determined based on collected map data} and has a visual appearance associated with the first state. In this example, portion 614a has solid line borders. As illustrated in FIG. 2A, the navigation application instructs (e.g., textually by 610a and graphically by 614a) a user to turn right at the next juncture.

FIG. 2B illustrates navigation user interface 610 as it appears at a time after the scenario in FIG. 2A, but while the same navigation session (e.g., still navigating to the same destination) is continued. In FIG. 2B, navigation instruction 610a is updated to display “Proceed Straight,” map 610b is updated to depict a current surrounding geographic area, and arrival information 610c remains unchanged. Navigation user interface 610 in FIG. 2B also includes path confirmation user interface 620. In some embodiments, a path confirmation user interface (e.g., 620) includes a map area (e.g., 620a) that includes a recommended navigation path (e.g., 614a) for upcoming navigation. In some embodiments, the path confirmation user interface also includes a message area (e.g., 620b) indicating (e.g., prompting) that user input is required to continue navigation, a selectable icon (e.g., 620c) for confirming the recommended path, and a selectable icon (e.g., 620d) for declining the recommended path. In the example of FIG. 2B, the map data meets criteria for the third state described above {insufficient map data from storage resource; recommended path can be determined based on collected map data}. In this example, the third state criteria are met because the navigation application does not receive sufficient data from a verified source but is able to collect enough map data from an unverified source and a plurality of sensors on computer system 600 in order to recommend a navigation path. The collected map data can be used as the basis to recommend a path as illustrated by navigation path 614a in FIG. 2B (e.g., a recommended turn to the left at the next juncture). However, because the navigation recommendation is not entirely based on data from the verified source, the navigation application is configured to prompt for user input confirmation by displaying path confirmation user interface 620. Prompting a user (e.g., instead of proceeding automatically) can be preferable because the confidence of navigation recommendation based on map data from a storage resource (e.g., a verified source) can generally be (or always be) higher than if it comes from an alternative source (e.g., an unverified source), and the prompt serves to attain user consent to proceed with navigation even though confidence may be lower and/or indicate to the user that navigation is occurring in an area of lower confidence data (e.g., requiring more user attention and/or intervention). In FIG. 2B, computer system 600 receives user input 621 (e.g., a tap gesture) on icon 620c for confirming the recommended path indicated by navigation path 614a.

In some embodiments, map data collected from a source other than the storage resource includes map data received from and/or based on crowdsourced data. In some embodiments, the crowdsourced data includes and/or is based on one or more previous navigation routes (e.g., one or more navigation routes successfully traversed by one or more other devices).

FIG. 2C illustrates navigation user interface 610 for interacting with different map data in response to computer system 600 receiving user input 621 in FIG. 2B. As shown in FIG. 2C, navigation user interface 610 now includes updated navigation instruction 610a (e.g., instructing the user to turn left at the next juncture, matching the confirmed recommended navigation path from FIG. 2B). In some embodiments, a navigation path (e.g., 614a) maintains a visual appearance associated with state of the map data prior to confirmation of the recommend path. For example, in FIG. 2C navigation path 614a maintains the visual appearance of having dotted line borders as it appeared in FIG. 2B. This can inform a user that this portion of navigation involves map data associated with the third state (e.g., and thus lower confidence map data).

FIG. 2D illustrates navigation user interface 610 after the device being navigated performs the left turn instructed in FIG. 2C. In this example, computer system 600 continually updates the displayed map area to display the real-time location of the device being navigated relative to the map (e.g., represented by indicator 612 within the map area). This can be performed using location data such as global positioning system (GPS) data. In some embodiments, a navigation path maintains a visual appearance associated with state of the map data prior to confirmation of the recommend path even after the associated area is traversed. For example, in FIG. 2D navigation path 614b maintains the visual appearance of having a dotted line border as it had prior to the corresponding portion of the map area having been traversed (e.g., indicator 612 in FIG. 2C traversed along the navigation path and into the dotted line region, and so in FIG. 2D the navigation path 614b already traversed keeps the dotted line appearance). Note that even though navigation paths 614a and 614b in FIG. 2D both have dotted line borders, they are not necessarily identical. In this example, navigation path 614a includes shading to indicate the upcoming navigation route, but navigation path 614b does not include the shading. Navigation path 614a also keeps the visual appearance associated with the third state. In some embodiments, after traversal of the corresponding map area, a navigation path changes in a manner that it matches the visual appearance of one or more other states. For example, navigation portion 614b in FIG. 2D could instead have solid line borders (as in FIG. 2C), which matches the appearance of traversed paths associated with map data having the first state (e.g., all traversed paths can be indicated the same visually, such as with a solid border line).

FIG. 2E illustrates navigation user interface 610 as displayed in response to the navigation application reaching a point where no recommended path can be determined for the device being navigated, and is displayed after the device being navigated continues proceeding forward as instructed in FIG. 2D. For example, the map data for this area can be associated with the fourth state described above {insufficient map data from storage resource; no recommended path can be determined based on collected map data}. In some embodiments, in response to determining that map data is associated with a certain state (e.g., the fourth state), the device (e.g., computer system 600) requires user input of a navigation path. For example, navigation instruction 610a in navigation user interface 610 of FIG. 2E includes a prompt for a user to input a navigation path (asking “How to proceed?”). Additionally, navigation path 614a is displayed with a visual appearance indicating the user input is required (e.g., displayed as an incomplete segment). In FIG. 2E, computer system 600 receives user input 623 (e.g., a swipe gesture to the left) on map 610b, representing a command to the navigation application for navigation to proceed to the left (e.g., make a left turn).

FIG. 2F illustrates navigation user interface 610 as it appears in response to computer system 600 receiving user input 623 in FIG. 2E. In FIG. 2F, navigation user interface 610 also includes invalid path user interface 630. In some embodiments, an invalid path user interface (e.g., 630) includes one or more of an indication that navigation path created or requested based on user input (e.g., 623) is invalid (e.g., not possible, not safe, obstructed, and/or the like), an option to retry user input (e.g., icon 630b), and/or an option to end navigation (e.g., icon 630c). For example, subsequent to receiving user input 623, computer system 600 determines (e.g., based on sensor data) that a left turn is not safe. In FIG. 2F, computer system 600 receives user input 631 (e.g., a tap gesture) on icon 630b for retrying user input of navigation path. In some embodiments, receiving user input representing selection of an option to end navigation (e.g., user input selection of icon 630c) causes one or more of the following actions: a navigation session ends (e.g., the current trip is ended), a device being navigated stops (e.g., if the device being navigated can receive and act upon relevant instructions), a device being navigated backs up (e.g., and returns to another location) (e.g., if the device being navigated can receive and act upon relevant instructions).

FIG. 2G illustrates exemplary navigation user interface 610 (returned to the same scenario as described in FIG. 2E) as displayed in response to computer system 600 receiving user input 631. In some embodiments, user input defining a path can include one or more valid gesture types. For example, a valid gesture can be a continuous gesture such as a swipe (as shown in FIG. 2E) for indicating a location and/or direction associated with a desired navigation maneuver (e.g., which may nonetheless define an invalid path as determined by sensor data). As another example, an additional or alternative valid gesture can be non-continuous gesture such as a series of inputs defining points along a desired navigation path as shown in FIG. 2G. These points can be interpolated between to determine the desired navigation path. In FIG. 2G, computer system 600 receives user input 633 and then user input 635 (e.g., both being a tap gesture) on map 610b, collectively representing a command for navigation to proceed forward to the location of user input 633 and then proceed to the right to the location of user input 635 (e.g., resulting in a right turn). In some embodiments, user input defining and/or confirming a navigation path includes voice input. For example, at navigation user interface 610 in FIG. 2B voice input (“Yes”) can cause the same result as user input 621, and/or at navigation user interface 610 in FIG. 2G voice input (“turn right”) can cause the same result as user input 633 and user input 635.

In some embodiments, user input defining a path can include one or more user inputs corresponding to selection on a representation of the intended traversal area (e.g., area in front of the device being navigated). For example, at FIGS. 2E and 2G, map 610b can be computer generated graphics and/or include a camera view of what the intended traversal area looks like (e.g., from one or more cameras attached to the device being navigated).

FIG. 2H illustrates exemplary navigation user interface 610 as it appears in response to computer system 600 receiving user input 633 and user input 635 in FIG. 2G. As illustrated in FIG. 2H, navigation user interface 610 includes updated navigation instruction 610a (which now instructs “Turn Right”) and navigation path 614a in the shape of the path defined by user input 633 and user input 635. At FIG. 2H, navigation path 614a is based on map data associated with the fourth state {insufficient map data from storage resource; no recommended path can be determined based on collected map data without user input} and has a visual appearance associated with the fourth state (e.g., appears as a single, solid line). The visual appearance of navigation path 614a can indicate that this portion of the navigation is user defined. As navigation proceeds through the user defined portion, navigation paths 614a and 614b can behave as described above with respect to the other visual appearances (e.g., navigation path 614b can be a single, solid line indicating a user defined path has been traversed, or can change to a thicker line having solid borders as shown in FIG. 2C).

In summary, the examples described with respect to FIGS. 2A-2H illustrate three distinct scenarios that each correspond to a different map data state. In FIG. 2A, map data associated with the first state described above does not require user input intervention. In FIG. 2B, map data associated with the third state described above results in the navigation application being able to infer a recommend navigation path, which is presented at a user interface that requires user input intervention to confirm. In FIGS. 2E and 2G, map data associated with the fourth state described above results in the navigation application not being able to infer a recommend navigation path and instead requires ad-hoc user input intervention to determine a navigation path.

In some embodiments, while awaiting valid user input to define and/or confirm a navigation path, the device being navigated performs a waiting maneuver (e.g., if it includes movement capability). For example, prior to receiving user input 621 of FIG. 2B, and/or user input 633 and user input 635 of FIG. 2G, the device being navigated can stop moving and wait for instructions. The device being navigated can maintain the waiting maneuver until valid user input is received (e.g., and not resume or continue further movement in response to user input 623 of FIG. 2E).

In some embodiments, a user interface and/or prompt for requesting user input can be displayed at a threshold (e.g., predetermined) distance away from the location represented by the map data requiring the user input (e.g., a half mile away from where the navigation instruction is needed, such as at the border of a map data state change from first state to third state). In some embodiments, a user interface and/or prompt for requesting user input can be displayed at a threshold (e.g., predetermined) time until arrival away from the location represented by the map data requiring the user input (e.g., one minute before arrival at where the navigation instruction is needed, based on current travel speed).

In some embodiments, the device being navigated corresponds to (e.g., is associated with, logged into, and/or assigned to) a particular user (e.g., user account, such as a user account belonging to the owner of the vehicle). In some embodiments, the device being navigated is connected to (e.g., in communication with) a plurality of devices. For example, the device being navigated can be connected to two other devices: a different device of the owner (e.g., a smartphone displaying navigation user interface 610) and a device of a guest (e.g., a user other than the owner). In some embodiments, a user interface and/or prompt for requesting user input is displayed at one or more of the plurality of devices connected to the device being navigated. For example, the owner's different device can display navigation user interface 610 prompting for user input whereas the device of the guest does not display navigation user interface 610. In this way, the device being navigated can prompt for input from certain users and/or devices preferentially and/or sequentially. In some embodiments, the device being navigated is connected to one other device. For example, the one other device can display a user interface and/or prompt requesting user input depending on whether the one other device corresponds to the owner of the device being navigated (e.g., and/or belongs to a set of users, such as registered users, authorized users, and/or trusted users). In some embodiments, if the one other device is a device of a guest (e.g., not the owner), the one other device does not display navigation user interface 610. In some embodiments, if the one other device is a different device of the owner, the one other device does display navigation user interface 610. For example, a device the owner, but not a device of a guest, can be prompted and provide instructions to the device being navigated for navigating through areas with insufficient map data. However, by not prompting certain users (e.g., guests) in the same way as the owner, the device being navigated can be prevented from being navigated through such areas (e.g., which can be a preference of and/or made by the owner).

In some embodiments, the device being navigated and the device displaying navigation user interfaces (e.g., 610 in FIGS. 2A-2H) are the same device. For example, computer system 600 displays the user interfaces and is tracking and updating navigation based on its own location and movement. In some embodiments, the device being navigated and the device displaying navigation user interfaces (e.g., 610 in FIGS. 2A-2H) are different devices. For example, computer system 600 displays the user interfaces but is tracking and updating navigation based on the location and movement of another device (e.g., for guiding another smartphone; for guiding a device with autonomous and/or semi-autonomous movement capabilities). In some embodiments, the navigation user interfaces are displayed on a shared screen. For example, the navigation interfaces can be displayed on a touchscreen of a vehicle that is attached to computer device 600 (e.g., a user connects their smartphone via a wire or wirelessly to a computer inside of their vehicle, causing a display of the vehicle to be controlled by an operating system of the smartphone (e.g., like Apple CarPlay)).

FIG. 3 is a flow diagram illustrating a method for interacting with different map data using a computer system in accordance with some embodiments. Process 700 is performed at a computer system (e.g., system 100). The computer system is in communication with one or more output components. Some operations in process 700 are, optionally, combined, the orders of some operations are, optionally, changed, and some operations are, optionally, omitted.

As described below, process 700 provides an intuitive way for interacting with different map data. The method reduces the cognitive burden on a user for interacting with different map data, thereby creating a more efficient human-machine interface. For battery operated computing devices, enabling a user to interact with different map data faster and more efficiently conserves power and increases the time between battery charges.

In some embodiments, process 700 is performed at a computer system (e.g., 600) that is in communication with one or more output components (e.g., 602) (e.g., a display screen, a touch-sensitive display, a haptic output component, and/or a speaker). In some embodiments, the computer system is a watch, a fitness tracking device, a phone, a tablet, a processor, a head-mounted display (HMD) device, and/or a personal computing device. In some embodiments, the computer system is in communication with one or more input devices (e.g., a physical input mechanism, a camera, a touch-sensitive display, a microphone, and/or a button).

The computer system receives (702) a request (e.g., as described above with respect to FIGS. 2A-2H) to navigate to a first destination (e.g., as described above with respect to FIGS. 2A-2H). In some embodiments, the request is received via a map application (e.g., an application configured to provide directions to destinations). In some embodiments, receiving the request includes detecting, via a sensor in communication with the computer system, input (e.g., a dragging input or, in some examples, a non-dragging input (e.g., a rotational input, an air gesture, a mouse click and drag input, a voice input, a swipe input, and/or a gaze input)). In some embodiments, the request is received via a determination by the computer system to navigate to the first destination.

In response to receiving the request (e.g., as described above with respect to FIGS. 2A-2H), the computer system initiates (704) navigation to the first destination (e.g., as described above with respect to FIGS. 2A-2H) (e.g., displaying navigation interface 610 as illustrated in FIG. 2A). In some embodiments, navigating to the first destination includes providing, via at least one output component of the one or more output components, one or more maneuvers (e.g., directions). In some embodiments, navigating to the first destination includes causing a physical component in communication with the computer system to change position.

While (706) navigating to the first destination (e.g., as illustrated in FIG. 2A) (e.g., after initiating navigation to the first destination, such as after providing at least one maneuver (e.g., a direction) with respect to navigating to the first destination), in accordance with a determination that an intended traversal area (e.g., represented by 614a) (e.g., an upcoming traversal area, a next traversal area, a future traversal area, and/or an area for which the computer system has determined to navigate to and/or through) includes a first quality of map data (e.g., represented by navigation path 614a of FIGS. 2B, 2C, 2D, 2E, and/or 2G) (e.g., map data associated with the second state, third state, and/or fourth state as described with respect to FIGS. 2A-2H) (e.g., a first level of map data, an amount of map data below a threshold, an inadequate amount of map data, and/or map data with a confidence level below a threshold), the computer system requests (708), via the one or more output components, input (e.g., a dragging input or, in some examples, a non-dragging input (e.g., a rotational input, an air gesture, a mouse click and drag input, a voice input, a swipe input, and/or a gaze input)) with respect to an upcoming maneuver (e.g., displaying path confirmation user interface 620, navigation instruction 610a of FIG. 2E, and/or navigation instruction 610a of FIG. 2G) (e.g., a maneuver, a next maneuver, a direction, a next direction, and/or an upcoming direction, such as “go straight,” “turn left,” and/or “turn right”). In some embodiments, the requesting includes outputting, via a speaker of the one or more output components, an audio request with respect to the next maneuver. In some embodiments, the requesting includes displaying, via a display component of the one or more output components, a visual request with respect to the next maneuver. In some embodiments, the first quality of map data is determined based on metadata corresponding to the intended traversal area. In some embodiments, the first quality of map data is determined based on a confidence level corresponding to the intended traversal area.

While (706) navigating to the first destination, in accordance with a determination that the intended traversal area includes a second quality of map data (e.g., represented by navigation path 614a of FIG. 2A) (e.g., map data associated with the first state as described with respect to FIGS. 2A-2H) (e.g., predefined map data, map data including one or more potential routes through the intended traversal area, and/or map data determined based on data detected via one or more sensors in communication with the computer system) different from the first quality of map data (e.g., represented by navigation path 614a of FIGS. 2B, 2C, 2D, 2E, and/or 2G) (e.g., map data associated with the second state, third state, and/or fourth state as described with respect to FIGS. 2A-2H), the computer system forgoes (710) requesting input with respect to the upcoming maneuver (e.g., forgoing displaying path confirmation user interface 620, navigation instruction 610a of FIG. 2E, and/or navigation instruction 610a of FIG. 2G) (e.g., continuing to display navigation user interface 610 as in FIG. 2A). In some embodiments, in accordance with the determination that the intended traversal area includes the second quality of map data, outputting, via a speaker of the one or more output components, the upcoming maneuver. In some embodiments, in accordance with the determination that the intended traversal area includes the second quality of map data, displaying, via a display component of the one or more output components, the upcoming maneuver. In some embodiments, in accordance with the determination that the intended traversal area includes the second quality of map data, providing, via an output component, the upcoming maneuver without additional input required after initiating navigation to the first destination. In some embodiments, the first quality of map data is determined to be of lower quality (e.g., includes less data, includes data that corresponds to less detailed map data, and/or does not include data that is included in the second quality of map data) than the second quality of map data. Requesting input with respect to the upcoming maneuver when the intended traversal area includes the first quality of map data provides the user with different functionality depending on the quality of map data for the intended traversal area, thereby reducing the number of inputs needed to perform an operation, providing additional control options without cluttering the user interface with additional displayed controls, and/or performing an operation when a set of conditions has been met without requiring further user input.

In some embodiments, while navigating to the first destination (e.g., as described above with respect to FIGS. 2A-2H), in accordance with the determination that the intended traversal area includes the second quality of map data, the computer system performs the upcoming maneuver (e.g., performing the maneuver represented by navigation path 614a of FIG. 2A) (e.g., displaying a representation of the upcoming maneuver and/or causing the computer system to be navigated according to the upcoming maneuver) without receiving input (e.g., a dragging input or, in some examples, a non-dragging input (e.g., a rotational input, an air gesture, a mouse click and drag input, a voice input, a swipe input, and/or a gaze input)) with respect to the upcoming maneuver (e.g., 614a of FIG. 2A) (e.g., since initiating navigation to the first destination and/or since receiving input with respect to a maneuver before the upcoming maneuver). In some embodiments, before navigating to the first destination, a route to the first destination is selected via input (e.g., a dragging input or, in some examples, a non-dragging input (e.g., a rotational input, an air gesture, a mouse click and drag input, a voice input, a swipe input, and/or a gaze input)) and the route includes the upcoming maneuver. In some embodiments, before navigating to the first destination, a route to the first destination is selected via input and no further include is received with respect to the upcoming maneuver. In some embodiments, the second quality of map data was contributed by a third party (e.g., a person or company in control of the intended traversal area and/or a person, company, and entity that has visited, selected, and/or navigated the intended area) and not a manufacturer of the computer system. In some embodiments, the second quality of map data is verified by a mapping software performing the upcoming maneuver. In some embodiments, the second quality of map data is verified by a user associated with the mapping software. Performing the upcoming maneuver when the intended traversal area includes the second quality of map data provides the user with functionality without the user needing to directly request such functionality, thereby reducing the number of inputs needed to perform an operation and/or performing an operation when a set of conditions has been met without requiring further user input.

In some embodiments, while navigating to the first destination (e.g., as described above with respect to FIGS. 2A-2H), in accordance with the determination that the intended traversal area includes the first quality of map data and after (e.g., while and/or in conjunction with) a computer-generated path (e.g., 614a in FIG. 2B) (e.g., the computer-generated path is a recommended path and/or a determined path through the intended traversal area and/or through locations that correspond to the intended traversal area) corresponding to the upcoming maneuver is displayed (e.g., via the display component and/or via a second computer system that is different from the computer system), the computer system receives input (e.g., 621) (e.g., a tap input or, in some examples, a non-tap input (e.g., a rotational input, an air gesture, a mouse click, a mouse click and drag input, a voice input, a swipe input, and/or a gaze input)) corresponding to approval of the computer-generated path. In some embodiments, the computer-generated path includes the upcoming maneuver. In some embodiments, the computer-generated path is generated without input from a user of the computer system. In some embodiments, while navigating to the first destination, in response to receiving the input, the computer system performs the upcoming maneuver (e.g., performing the maneuver represented by navigation path 614a of FIG. 2B) according to the computer-generated path (e.g., 614a of FIG. 2B). In some embodiments, in response to receiving input corresponding to rejection of the computer-generated path causes display of a second computer-generated path different from the computer-generated path. Performing the upcoming maneuver according to the computer-generated path when approval of the path is received provides the user the ability to decide whether a path that was generated for the user is what the user wants, thereby reducing the number of inputs needed to perform an operation, providing additional control options without cluttering the user interface with additional displayed controls, and/or performing an operation when a set of conditions has been met without requiring further user input.

In some embodiments, the computer-generated path is generated based on data captured by one or more sensors that are in communication with the computer system. In some embodiments, the one or more sensors are included within and/or attached to a housing includes within and/or has attached the one or more output components. In some embodiments, the one or more sensors do not detect a location (e.g., via a global positioning system) but rather detects one or more objects in a physical environment. In some embodiments, the computer-generated path is generated based on data captured by a plurality of sensors in communication with the computer system. In some embodiments, the one or more sensors includes a camera and the data includes an image captured by the camera. In some embodiments, the one or more sensors includes a radar, lidar, and/or another ranging sensor. Generating the computer-generated path based on data captured by one or more sensors that are in communication with the computer system ensures that the computer-generated path is based on current data and not data that was detected previously, thereby adapting to a current context and/or state of a physical environment.

In some embodiments, the computer-generated path is generated based on data captured by a different computer system separate from the computer system. In some embodiments, the different computer system is remote from and/or not physically connected to the computer system. In some embodiments, the computer-generated path is generated based on a heat map determined based on data collected from a plurality of different computer systems. In some embodiments, the plurality of different computer systems is not in communication with the computer system but rather are in communication with the different computer system that is in communication with the computer system. In some embodiments, the different computer system is in wireless communication with the computer system, such as via the Internet. In some embodiments, the data is received by the computer system in a message sent by the different computer system. In some embodiments, the different computer system generates the computer-generated path, and the computer system receives the computer-generated path from the different computer system. Generating the computer-generated path based on data captured by the different computer system provides the ability for operations to be performed and/or data to be detected by computer systems different from the computer system, thereby offloading such operations to different processors and/or allowing for different types of data to be detected/used when the computer system might not be in communication with such sensors.

In some embodiments, while navigating to the first destination (e.g., as described above with respect to FIGS. 2A-2H), in accordance with a determination that the intended traversal area includes a third quality of map data (e.g., represented by navigation path 614a of FIGS. 2E, and/or 2G) (e.g., map data associated with the fourth state as described with respect to FIGS. 2A-2H) (e.g., the second quality of map data or a quality of map data different from the first and second quality of map data), the computer system receives input (e.g., 623, 633, and/or 635) (e.g., a dragging input or, in some examples, a non-dragging input (e.g., a rotational input, an air gesture, a mouse click and drag input, a voice input, a swipe input, and/or a gaze input)) corresponding to a path (e.g., defined by 623, 633, and/or 635) (e.g., a navigation path and/or one or more instructions for navigating with respect to the intended traversal area) with respect to the intended traversal area. In some embodiments, the third quality of map data is the second quality of map data. In some embodiments, the path is generated based on the input. In some embodiments, the third quality of map data is a lower quality of map data than the second quality of map data. In some embodiments, while navigating to the first destination, after receiving the input corresponding to the path and in accordance with a determination that the path meets a first set of criteria, the computer system navigates (e.g., with respect to the intended traversal area) via the path (e.g., navigating via 614a of 2H). In some embodiments, after receiving the input corresponding to the path and in accordance with a determination that the path does not meet the first set of criteria, forgoing navigating via the path (e.g., request a different path). In some embodiments, the first set of criteria includes a criterion that is met when the path is determined to be navigable by the computer system. In some embodiments, the path is determined to be navigable by the computer system based on data captured by one or more sensors in communication with the computer system. In some embodiments, the path is determined to be navigable by the computer system based on one or more objects detected in the intended traversal area. Navigating via the path when the path meets the first set of criteria ensures that the path is accepted by the computer system and that not just any path will be used for navigation, thereby reducing the number of inputs needed to perform an operation, providing additional control options without cluttering the user interface with additional displayed controls, and/or performing an operation when a set of conditions has been met without requiring further user input.

In some embodiments, while navigating to the first destination (e.g., as described above with respect to FIGS. 2A-2H) (e.g., while displaying navigation interface 610), in accordance with the determination that the intended traversal area includes the third quality of map data (e.g., while displaying navigation interface 610 of FIG. 2E) and after receiving the input (e.g., 623) corresponding to the path, in accordance with a determination that the path does not meet the first set of criteria, the computer system forgoes navigating via the path (e.g., and displaying invalid path user interface 630) (e.g., rejecting the path and, in some examples, requesting input corresponding to a different path), wherein the determination that the path does not meet the first set of criteria is based on data detected by one or more sensors in communication with the computer system. In some embodiments, the one or more sensors do not detect a location of the computer system but rather detect a characteristic (e.g., an object, a surface, and/or a path within) of a physical environment. Forgoing navigating via the path when the path does not meet the first set of criteria ensures that not just any path will be used for navigation, thereby reducing the number of inputs needed to perform an operation, providing additional control options without cluttering the user interface with additional displayed controls, and/or performing an operation when a set of conditions has been met without requiring further user input.

In some embodiments, while navigating to the first destination (e.g., as described above with respect to FIGS. 2A-2H), in accordance with the determination that the intended traversal area includes the second quality of map data (e.g., represented by navigation path 614a of FIG. 2A) (e.g., map data associated with the first state as described with respect to FIGS. 2A-2H) and after performing the upcoming maneuver without receiving input with respect to the upcoming maneuver (e.g., represented by navigation path 614a of FIG. 2A), in accordance with a determination a second intended traversal area includes the first quality of map data (e.g., represented by navigation path 614a of FIGS. 2B, 2C, 2D, 2E, and/or 2G) (e.g., map data associated with the second state, third state, and/or fourth state as described with respect to FIG. 2A-2H), the computer system requests, via the one or more output components, input (e.g., a dragging input or, in some examples, a non-dragging input (e.g., a rotational input, an air gesture, a mouse click and drag input, a voice input, a swipe input, and/or a gaze input)) with respect to a second upcoming maneuver different from the upcoming maneuver (e.g., displaying path confirmation user interface 620, navigation instruction 610a of FIG. 2E, and/or navigation instruction 610a of FIG. 2G). In some embodiments, requesting input with respect to the second upcoming maneuver is in a different form than requesting input with respect to the upcoming maneuver (e.g., one includes providing a suggested path while the other requires a user to identify at least one or more points to use to generate a path). In some embodiments, the second intended traversal area is different from the intended traversal area. Requesting input with respect to the second upcoming maneuver after performing the upcoming maneuver without receiving input with respect to the upcoming maneuver ensures that the computer system only requests user input for some maneuvers and not other maneuvers, thereby reducing the number of inputs needed to perform an operation, providing additional control options without cluttering the user interface with additional displayed controls, and/or performing an operation when a set of conditions has been met without requiring further user input.

In some embodiments, a first path corresponding to the upcoming maneuver has a first visual appearance (e.g., visual appearance of 614a in FIGS. 2A, 2B, 2D, 2E, 2G, and/or 2H) and a second path corresponding to the second upcoming maneuver has a second visual appearance different (e.g., visual appearance of 614a in FIGS. 2A, 2B, 2D, 2E, 2G, and/or 2H) from (e.g., a different color, pattern, line weight, line segmentation (e.g., solid lines v. dotted lines), and/or size) the first visual appearance. In some embodiments, the first visual appearance indicates a first respective quality of map data (e.g., map data associated with the first state, second state, third state, and/or fourth state as described with respect to FIG. 2A-2H) and the second visual appearance indicates a second respective quality of map data (e.g., map data associated with the first state, second state, third state, and/or fourth state as described with respect to FIG. 2A-2H) different from the first respective quality of map data. In some embodiments, the second upcoming maneuver is the same type of maneuver as the upcoming maneuver (e.g., the same maneuver). Different paths having different visual appearances based on the amount of input required for a path provides the user with feedback about the state of the computer system and an amount of confidence that the user should have in a particular path, thereby providing improved visual feedback to the user.

Note that details of the processes described above with respect to process 700 (e.g., FIG. 3) are also applicable in an analogous manner to the methods described below/above. For example, process 800 optionally includes one or more of the characteristics of the various methods described above with reference to process 700. For example, the computer system of process 800 can be the computer system of process 700. For brevity, these details are not repeated below.

FIG. 4 is a flow diagram illustrating a method for interacting with different map data using a computer system in accordance with some embodiments. Process 800 is performed at a computer system (e.g., system 100). The computer system is in communication with one or more output components. Some operations in process 800 are, optionally, combined, the orders of some operations are, optionally, changed, and some operations are, optionally, omitted.

As described below, process 800 provides an intuitive way for interacting with different map data. The method reduces the cognitive burden on a user for interacting with different map data, thereby creating a more efficient human-machine interface. For battery operated computing devices, enabling a user to interact with different map data faster and more efficiently conserves power and increases the time between battery charges.

In some embodiments, process 800 is performed at a computer system (e.g., 600) that is in communication with one or more output components (e.g., 602) (e.g., display screen, a touch-sensitive display, a haptic output device, and/or a speaker). In some embodiments, the computer system is a watch, a fitness tracking device, a phone, a tablet, a processor, a head-mounted display (HMD) device, and/or a personal computing device. In some embodiments, the computer system is in communication with one or more input devices (e.g., a physical input mechanism, a camera, a touch-sensitive display, a microphone, and/or a button).

The computer system receives (802) a request to navigate to a first destination (e.g., a request to display navigation interface 610 of FIG. 2A). In some embodiments, the request is received via a map application (e.g., an application configured to provide directions to destinations). In some embodiments, receiving the request includes detecting, via a sensor in communication with the computer system, input (e.g., a dragging input or, in some examples, a non-dragging input (e.g., a rotational input, an air gesture, a mouse click and drag input, a voice input, a swipe input, and/or a gaze input)). In some embodiments, the request is received via a determination by the computer system to navigate to the first destination.

In response to receiving the request (e.g., a request to display navigation interface 610 of FIG. 2A), the computer system initiates (804) navigation to the first destination (e.g., as described above with respect to FIG. 2A-2H) (e.g., as illustrated in FIG. 2A). In some embodiments, navigating to the first destination includes providing, via at least one output component of the one or more output components, one or more maneuvers (e.g., directions). In some embodiments, navigating to the first destination includes causing a physical component in communication with the computer system to change position.

While (806) navigating to the first destination (e.g., as described above with respect to FIG. 2A-2H) (e.g., as illustrated in FIG. 2A) (e.g., after initiating navigation to the first destination, such as after providing at least one maneuver (e.g., a direction) with respect to navigating to the first destination), in accordance with a determination that a set of one or more criteria is met, wherein the set of criteria includes a criterion that is met when a determination is made that an intended traversal area (e.g., an upcoming traversal area, a next traversal area, a future traversal area, and/or an area for which the computer system has determined to navigate to and/or through) includes inadequate map data (e.g., a first level of map data, predefined map data, map data including one or more potential routes through the intended traversal area, and/or map data determined based on data detected via one or more sensors in communication with the computer system) to determine an upcoming maneuver (e.g., a maneuver, a next maneuver, a direction, a next direction, and/or an upcoming direction, such as “go straight,” “turn left,” and/or “turn right”) (e.g., represented by navigation path 614a of FIGS. 2E and/or 2G) (e.g., map data associated with the fourth state as described with respect to FIG. 2A-2H), the computer system requests (808), via the one or more output components, input (e.g., 623, 633, and/or 635) (e.g., a dragging input or, in some examples, a non-dragging input (e.g., a rotational input, an air gesture, a mouse click and drag input, a voice input, a swipe input, and/or a gaze input)) with respect to the upcoming maneuver. In some embodiments, requesting includes outputting, via a speaker of the one or more output components, an audio request with respect to the upcoming maneuver. In some embodiments, requesting includes displaying, via a display component of the one or more output components, a visual request (e.g., a request for a user to select one or more points for which to include in the upcoming maneuver, a request for a user to draw a path to correspond to the upcoming maneuver, a request for a user to verbally describe the upcoming maneuver, and/or a request for a user to point or otherwise indicate a direction and/or area to include in the upcoming maneuver). In some embodiments, in accordance with a determination that the intended traversal area includes adequate map data to determine the upcoming maneuver, forgoing requesting input with respect to the upcoming maneuver. Requesting input with respect to the upcoming maneuver when the intended traversal area includes inadequate map data provides the user with different functionality depending on the map data for the intended traversal area, thereby reducing the number of inputs needed to perform an operation, providing additional control options without cluttering the user interface with additional displayed controls, and/or performing an operation when a set of conditions has been met without requiring further user input.

In some embodiments, after requesting input with respect to the upcoming maneuver, the computer system receives input (e.g., 623) (e.g., a drag input or, in some examples, a non-drag input (e.g., a tap input, a rotational input, an air gesture, a mouse click, a mouse click and drag input, a voice input, a swipe input, and/or a gaze input)) corresponding to a first path (e.g., 614a of FIG. 2H) (e.g., a drawn path, a path indicating movement and/or direction, and/or a path that is updated over time and/or while the computer system is moving) in a first representation (e.g., navigation user interface 610 of FIG. 2E) (e.g., a graphical representation, a line, a path, a textual representation, and/or a symbolic representation) of the intended traversal area. In some embodiments, the input is continuous input including input at a first position and a second position, wherein the path includes the first position and the second position. In some embodiments, the input includes a tap and hold gesture that begins at a first position and continues to a second position, where the path includes the first position and the second position. In some embodiments, the computer system navigates according to the path. In some embodiments, the input includes a drawing of a continuous line in the representation of the intended traversal area. Receiving input corresponding to the first path in the first representation provides the user a precise way for instructing the computer system where to navigate, thereby reducing the number of inputs needed to perform an operation and/or providing additional control options without cluttering the user interface with additional displayed controls.

In some embodiments, after requesting input with respect to the upcoming maneuver, the computer system receives input (e.g., 633, and/or 635) (e.g., a drag input or, in some examples, a non-drag input (e.g., a tap input, a rotational input, an air gesture, a mouse click, a mouse click and drag input, a voice input, a swipe input, and/or a gaze input)) corresponding to one or more points (e.g., centroids of 633, and/or 635) in a second representation (e.g., navigation user interface 610 of FIG. 2H) of the intended traversal area, wherein a second path is generated based on the one or more points. In some embodiments, the one or more points includes a plurality of points, wherein a line between the plurality of points is generated (e.g., using interpolation or some other operation to identify a path between the plurality of points). In some embodiments, the one or more points includes a point, wherein a line between a location of the computer system and the point is generated (e.g., using interpolation or some other operation to identify a path between the plurality of points). In some embodiments, the input includes a plurality of distinct input, each distinct input including detection of the distinct input and detection of a release of the distinct input. In some embodiments, the input includes a first input and a second input distinct (e.g., separate) from the first input. Receiving input corresponding to one or more points in the second representation provides the user a precise way for instructing the computer system where to navigate, thereby reducing the number of inputs needed to perform an operation and/or providing additional control options without cluttering the user interface with additional displayed controls.

In some embodiments, after requesting input with respect to the upcoming maneuver, the computer system receives (e.g., via a microphone that is in communication with the computer system) a voice request corresponding to the intended traversal area. In some embodiments, the voice request includes one or more verbal instructions for navigating with respect to the intended traversal area. Receiving the voice request corresponding to the intended traversal area provides the user a precise way for instructing the computer system where to navigate, thereby reducing the number of inputs needed to perform an operation and/or providing additional control options without cluttering the user interface with additional displayed controls.

In some embodiments, the navigation to the first destination is initiated along a third path (e.g., 614a of FIG. 2H) (e.g., a path through a physical environment and/or a path including one or more directions for navigating the physical environment). In some embodiments, a portion of the third path goes through the intended traversal area (e.g., the path is configured to navigate through and/or along the intended traversal area). In some embodiments, the path is determined by the computer system. In some embodiments, the computer system sends, to a device in communication with the computer system such as a server, a request for the path and, after sending the request, the computer system receives, from the device, the path. The navigation including the portion that requires input to go within provides the user the ability to navigate into areas for which map data accessible by the computer system is inadequate, thereby increasing the number of options available to the user and allowing for the user to save time while navigating to a destination.

In some embodiments, the navigation to the first destination is initiated along a fourth path (e.g., 614a of FIG. 2A) (e.g., a path through a physical environment, the path including one or more directions for navigating the physical environment). In some embodiments, the fourth path includes a respective portion that does not require an input (e.g., 621, 623, 633, and/or 635) (e.g., user input) (e.g., one or more respective inputs that are obtained to navigate through the respective portion) (e.g., one or more drag inputs and/or one or more non-drag inputs (e.g., a tap input, a rotational input, an air gesture, a mouse click, a mouse click and drag input, a voice input, a swipe input, and/or a gaze input)) to navigate through the respective portion (e.g., the path includes a maneuver to navigate through the portion without a user confirming the maneuver). In some embodiments, the path is determined by the computer system. In some embodiments, the computer system sends, to a device in communication with the computer system such as a server, a request for the path and, after sending the request, the computer system receives, from the device, the path. The navigation including the portion that does not require input to go through reduces the amount of input required by the user during navigation, thereby reducing the number of inputs needed to perform an operation and/or performing an operation when a set of conditions has been met without requiring further user input.

In some embodiments, the set of one or more criteria includes a criterion that is met when a determination is made that the computer system is within a first threshold distance (e.g., zero or more) (e.g., 1-10 meters) from the intended traversal area. In some embodiments, the first threshold distance is predefined and applied to all navigation and all portions of a navigation by the computer system. In some embodiments, the first threshold distance is based the intended traversal area and is different for different intended traversal areas (e.g., different intended traversal areas may be smaller or bigger and require different amount of time to handle) (e.g., different intended traversal areas may include different areas around them for stopping). Requesting input with respect to the upcoming maneuver when the intended traversal area is within the first threshold distance provides the user with options with respect to navigation at a time in which the user is in a position to provide input, thereby reducing the number of inputs needed to perform an operation, providing additional control options without cluttering the user interface with additional displayed controls, and/or performing an operation when a set of conditions has been met without requiring further user input.

In some embodiments, the set of one or more criteria includes a criterion that is met when a determination is made that the computer system is not moving (e.g., based on data detected by a sensor in communication with the computer system and/or based on a current maneuver being performed for navigating) and within a second threshold distance (e.g., zero or more) (e.g., 1-10 meters) from the intended traversal area. In some embodiments, the second threshold distance is predefined and applied to all navigation and all portions of a navigation by the computer system. In some embodiments, the second threshold distance is based the intended traversal area and is different for different intended traversal areas (e.g., different intended traversal areas may be smaller or bigger and require different amount of time to handle) (e.g., different intended traversal areas may include different areas around them for stopping). In some embodiments, in accordance with a determination that the computer system is moving, the computer system does not request input with respect to the upcoming maneuver. In some embodiments, in accordance with a determination that the computer system is not within the second threshold distance from the intended traversal area, the computer system does not request input with respect to the upcoming maneuver. Requesting input with respect to the upcoming maneuver when the computer system is not moving and within the second threshold distance from the intended traversal area provides the user with options with respect to navigation at a time in which the user is in a position to provide input, thereby reducing the number of inputs needed to perform an operation, providing additional control options without cluttering the user interface with additional displayed controls, and/or performing an operation when a set of conditions has been met without requiring further user input.

In some embodiments, after requesting input with respect to the upcoming maneuver, the computer system receives a set of one or more inputs including one or more inputs (e.g., 623, 633, and/or 635) (e.g., a dragging input or, in some examples, a non-dragging input (e.g., a rotational input, an air gesture, a mouse click and drag input, a voice input, a swipe input, and/or a gaze input)) with respect to the upcoming maneuver. In some embodiments, the set of one or more inputs includes input defining a path for the navigation to take with respect to the intended traversal area. In some embodiments, in response to receiving the set of one or more inputs including the one or more input with respect to the second upcoming maneuver, in accordance with a determination that a path resulting from the set of one or more input does not meet a first set of criteria, the computer system requests (e.g., displaying invalid path user interface 630 of FIG. 2F), via the one or more output components, different input (e.g., 631) (e.g., a dragging input or, in some examples, a non-dragging input (e.g., a rotational input, an air gesture, a mouse click and drag input, a voice input, a swipe input, and/or a gaze input)) with respect to the upcoming maneuver (e.g., without initiating navigation of the upcoming maneuver). In some embodiments, the first set of criteria includes a criterion that is met when the path is determined to be safe and/or possible to be navigated by the computer system. In some embodiments, the first set of criteria includes a criterion that is met based on one or more objects identified in a physical environment corresponding to the path. In some embodiments, in accordance with a determination that the path resulting from the set of one or more inputs does not meet the first set of criteria, the computer system forgoes requesting, via the one or more output components, different input with respect to the upcoming maneuver and/or initiates navigation of the upcoming maneuver. Requesting different input when the path does not meet the first set of criteria ensures that not just any path will be used for navigation, thereby reducing the number of inputs needed to perform an operation, providing additional control options without cluttering the user interface with additional displayed controls, and/or performing an operation when a set of conditions has been met without requiring further user input.

Note that details of the processes described above with respect to process 800 (e.g., FIG. 4) are also applicable in an analogous manner to the methods described below/above. For example, process 700 optionally includes one or more of the characteristics of the various methods described above with reference to process 800. For example, the computer system of process 700 can be the computer system of process 800. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with one or more output components:
receiving a request to navigate to a first destination;
in response to receiving the request, initiating navigation to the first destination; and
while navigating to the first destination:
in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

2. The method of claim 1, further comprising:
after requesting input with respect to the upcoming maneuver, receiving input corresponding to a first path in a first representation of the intended traversal area.

3. The method of claim 1, further comprising:
after requesting input with respect to the upcoming maneuver, receiving input corresponding to one or more points in a second representation of the intended traversal area, wherein a second path is generated based on the one or more points.

4. The method of claim 1, further comprising:
after requesting input with respect to the upcoming maneuver, receiving a voice request corresponding to the intended traversal area.

5. The method of claim 1, wherein the navigation to the first destination is initiated along a third path, and wherein a portion of the third path goes through the intended traversal area.

6. The method of claim 5, wherein the navigation to the first destination is initiated along a fourth path, and wherein the fourth path includes a respective portion that does not require an input to navigate through the respective portion.

7. The method of claim 1, wherein the set of one or more criteria includes a criterion that is met when a determination is made that the computer system is within a first threshold distance from the intended traversal area.

8. The method of claim 1, wherein the set of one or more criteria includes a criterion that is met when a determination is made that the computer system is not moving and within a second threshold distance from the intended traversal area.

9. The method of claim 1, further comprising:
after requesting input with respect to the upcoming maneuver, receiving a set of one or more inputs including one or more inputs with respect to the upcoming maneuver; and
in response to receiving the set of one or more inputs including the one or more input with respect to the second upcoming maneuver:
in accordance with a determination that a path resulting from the set of one or more input does not meet a first set of criteria, requesting, via the one or more output components, different input with respect to the upcoming maneuver.

10. A non-transitory computer-readable storage medium storing one or more programs configured to be executed by one or more processors of a computer system that is in communication with one or more output components, the one or more programs including instructions for:
receiving a request to navigate to a first destination;
in response to receiving the request, initiating navigation to the first destination; and
while navigating to the first destination:
in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.

11. A computer system that is in communication with one or more output components, comprising:
one or more processors; and
memory storing one or more programs configured to be executed by the one or more processors, the one or more programs including instructions for:
receiving a request to navigate to a first destination;
in response to receiving the request, initiating navigation to the first destination; and
while navigating to the first destination:
in accordance with a determination that a set of one or more criteria is met, wherein the set of criteria includes a criterion that is met when a determination is made that an intended traversal area includes inadequate map data to determine an upcoming maneuver, requesting, via the one or more output components, input with respect to the upcoming maneuver.
